(19) United States
(12) Patent Application Publication
(10) Pub. No.: US 2026/0265091 A1
(43) Pub. Date: Sep. 10, 2026

(54) A LITHIUM EXTRACTION PROCESS THROUGH DECOUPLED ELECTROCHEMICAL PROCESSES

(71) Applicant: King Abdullah University of Science and Technology, Thuwal (SA)

(72) Inventors: Zhiping LAI, Thuwal (SA); Zhen LI, Thuwal (SA)

(21) Appl. No.: 18/868,012

(22) PCT Filed: May 23, 2023
(86) PCT No.: PCT/IB2023/055302

§ 371 Date: Nov. 21, 2024

Related U.S. Application Data
(60) Provisional application No. 63/344,823, filed on May 23, 2022.

(51) Int. Cl. C02F 1/469; C02F 1/461

(52) U.S. Cl. CPC C02F 1/4693; C02F 1/46109; C02F 2001/46133; C02F 2201/46115; C02F 2201/46135

(57) ABSTRACT

Embodiments of the present disclosure generally relate to a system and method for enriching lithium (Li) from seawater and other low-grade lithium resources and eventually leading to the extraction of lithium from these resources. More particularly, the method involves decoupled electrochemical adsorptive and releasing processes using lithium selectively adsorptive/releasing electrode pair, and the two processes are interconnected through an oxidative/reductive electrode pair to transport lithium from the lithium extraction compartment to the lithium collection compartment.

### CROSS-REFERENCE TO RELATED APPLICATION

This application claims benefit of U.S. Provisional Application No. 63/344,823 filed on May 23, 2022. U.S. Provisional Application No. 63/344,823 is incorporated herein by reference. A claim of priority is made.

### BACKGROUND

Lithium (Li) is quickly emerging as a strategically important commodity due to the rapid growth in demand for lithium batteries. Commercial lithium is mainly produced from land resources such as salt-lake brines and high-grade ores using a chemical precipitation process, which is technically and economically feasible only when the lithium concentration in the brine or ore is in the hundreds of part-per-million (ppm) level and low Mg/Li ratio of <10 (Mg=magnesium). However, the lithium reserve on land is limited, which is only 21 million tons (lithium carbonate equivalent, LCE). In 2021, the global annual demand for Li had sky-rocketed to 430,000 tons LCE, generating a structural deficit due to a supply shortage of 2,900 tons LCE and a record-high price surge of 258%. It is anticipated that the annual lithium demand will be 1.4-1.7 million tons LCE in 2030, and the Li deficit will then increase to at least 455,000 tons LCE per year. The lithium reserve on land is expected to be exhausted by 2080. Fortunately, low-grade salt-lake brines, namely “lithium resources,” contain 86 million tons of lithium, four times that in lithium reserves. For example, salt-lake brines in Bolivia contain as much lithium as that in all lithium reserves on earth, i.e., 21 million tons of lithium, 85% of which is stored in Salar de Uyuni salty lake with a lithium concentration of 331 ppm and Mg/Li ratio of 17.5. The Dead Sea contains 3~5 million tons of lithium with a lithium concentration of 30~50 ppm and an Mg/Li ratio of ca. 2000. Furthermore, seawater represents another huge reservoir that contains lithium ~10,000 times that in the land; however, the lithium concentration in seawater is only ~0.2 ppm. The high Mg/Li ratio and the low lithium concentration have prevented the lithium from being extracted by the current commercialized “lime-soda evaporation” process.

### SUMMARY

In general, embodiments of the present disclosure describe a method for extraction of lithium from lithium containing fluids, the method comprising: immersing a lithium adsorptive electrode and a reductive electrode in a lithium extraction chamber which comprises a lithium containing fluid and immersing a lithium releasing electrode and an oxidative electrode in a lithium collection chamber comprising a lithium collection fluid. The lithium adsorptive electrode is connected to a negative port of a power supply and the lithium releasing electrode is connected to a positive port of the power supply. Furthermore, the oxidative electrode and the reductive electrode are connected through electrical wires. This is followed by applying voltage to the lithium adsorptive electrode and the lithium releasing electrode sufficient for the lithium adsorptive electrode to adsorb lithium from the lithium containing fluid and the lithium releasing electrode to release lithium to the lithium collection fluid, wherein the lithium adsorptive electrode functions as a cathode and the lithium releasing electrode functions as an anode; and wherein the reductive electrode is reduced, and the oxidative electrode is oxidized.

Embodiments of the present disclosure also describe a system for extraction of lithium from lithium containing fluid, the system comprising a lithium extraction chamber including a lithium containing fluid; a lithium collection chamber including a lithium collection fluid; a lithium adsorptive/releasing electrode pair; wherein the lithium adsorptive electrode is in fluidic communication with the lithium extraction chamber; and wherein the lithium releasing electrode is in fluidic communication with the lithium collection chamber; a reductive/oxidative electrode pair; wherein the reductive electrode is in fluidic communication with the lithium extraction chamber and the oxidative electrode is in fluidic communication with the lithium collection chamber; a power supply; wherein the lithium adsorptive electrode is immersed in the lithium containing fluid and connected to a negative port of the power supply, and wherein the lithium releasing electrode is immersed in the lithium collection fluid and connected to the positive port of the power supply; and wherein the reductive electrode is immersed in the lithium containing fluid, and the oxidative electrode is immersed in the lithium collection fluid; and wherein the reductive electrode and the oxidative electrode are connected using an electrical wire; and wherein lithium is extracted without using membranes.

Embodiments of the present disclosure further describe a system for extraction of lithium from a lithium containing fluid, the system comprising, a lithium extraction chamber including a lithium containing fluid; a lithium collection chamber including a lithium collection fluid; a lithium adsorptive/releasing electrode pair; wherein the lithium adsorptive electrode is in fluidic communication with the lithium extraction chamber; and wherein the lithium releasing electrode is in fluidic communication with the lithium collection chamber; a fluid reductive/oxidative electrode pair; wherein the reductive electrode is in fluidic communication with the lithium extraction chamber and the oxidative electrode is in fluidic communication with the lithium collection chamber; a first membrane separating the lithium adsorptive electrode and the reductive electrode in the lithium extraction chamber sufficient to form a lithium extraction compartment and a reductive compartment; and a second membrane separating the lithium releasing electrode and the oxidative electrode in the lithium collection chamber sufficient to form a lithium collection compartment and an oxidative compartment; a power supply; wherein the lithium adsorptive electrode is immersed in the lithium containing fluid and connected to a negative port of the power supply, and wherein the lithium releasing electrode is immersed in the lithium collection fluid and connected to the positive port of the power supply; and wherein the reductive electrode is immersed in the lithium containing fluid, and the oxidative electrode is immersed in the lithium collection fluid; and wherein the reductive electrode and the oxidative electrode are connected using an electrical wire.

The details of one or more examples are set forth in the description below. Other features, objects and advantages will be apparent from the description and from the claims.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 is a flowchart illustrating the steps utilized in a method for extraction of lithium from lithium containing fluid and release to a lithium collection fluid, according to some embodiments.

FIG. 2 is a schematic representation of the system for decoupled electrochemical process to extract lithium from lithium containing fluids or solution and release to a lithium collection fluid or solution, according to some embodiments of the present disclosure.

FIG. 3 illustrates the structure of the lithium adsorptive electrode, according to some embodiments of the present disclosure.

FIG. 4 is a schematic diagram of a system for extracting lithium from lithium containing fluids using one pair of solid lithium adsorptive and releasing electrodes and one pair of liquid reductive and oxidative electrodes, according to some embodiments.

### DETAILED DESCRIPTION

In general, the embodiments of the present disclosure relate to a system and method for enriching lithium (Li) from seawater and other low-grade lithium resources and eventually leading to the extraction of lithium from these resources. More particularly, the method involves decoupled electrochemical adsorptive and releasing processes using lithium selectively adsorptive/releasing electrode pair, and the two processes are electrochemically interconnected through an oxidative/reductive electrode pair to transport lithium from the lithium extraction compartment to the lithium collection compartment.

Method of Extraction of Lithium from Lithium Containing Fluids

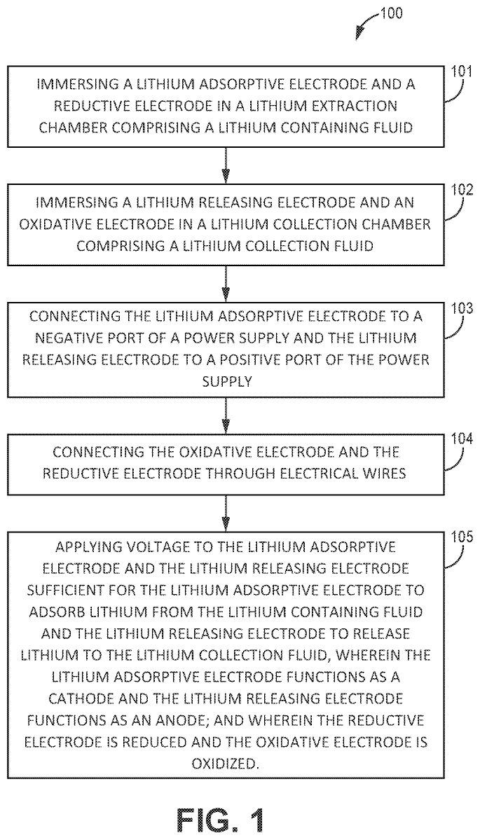

FIG. 1 is a flowchart illustrating the steps utilized in the extraction of lithium from lithium containing fluids. As shown in FIG. 1, the method may comprise immersing (101) a lithium adsorptive electrode and a reductive electrode in a lithium extraction chamber which comprises a lithium containing fluid. This is followed by immersing (102) a lithium releasing electrode and an oxidative electrode in a lithium collection chamber comprising a lithium collection fluid. The method further comprises connecting (103) the lithium adsorptive electrode to a negative port of a power supply and the lithium releasing electrode to a positive port of the power supply and connecting (104) the oxidative electrode and the reductive electrode through electrical wires. The method further comprises applying (105) voltage to the lithium adsorptive electrode and the lithium releasing electrode sufficient for the lithium adsorptive electrode to adsorb lithium from the lithium containing fluid and the lithium releasing electrode to release lithium to the lithium collection fluid; wherein the lithium adsorptive electrode functions as a cathode and the lithium releasing electrode functions as an anode; and wherein the reductive electrode is reduced, and the oxidative electrode is oxidized. Lithium is extracted from the lithium containing fluid to the lithium adsorptive electrode and released to the lithium collection fluid from the lithium releasing electrode.

The step 101 includes immersion of a lithium adsorptive electrode and a reductive electrode in a lithium extraction chamber, wherein the lithium extraction chamber comprises a lithium containing fluid. The step 102 includes immersion of a lithium releasing electrode and an oxidative electrode in a lithium collection chamber comprising a lithium collection fluid. The pair of lithium adsorptive and releasing electrodes are made from materials that can selectively adsorb lithium from other interference cations. For the lithium adsorptive electrode, these include, but are not limited to LiₓFePO₄, LiₓMnO₂, LiₓMn₂O₄, LiₓTiO₂, LiₓNiₐCo_{b}Mn_{c}O₂, LiₓFeₐMe_{b}PO₄ (Me=Mn, Co, Al, Ni, Nb, Mo, Ti, or their mixture, 0≤x≤1, 0<a≤1, 0<b≤1, 0<c≤1). The lithium releasing electrode is made of the corresponding lithium adsorbed form of the lithium adsorptive electrode, which includes, but is not limited to, Li_{x′}FePO₄, Li_{x′}MnO₂, Li_{x′}Mn₂O₄, Li_{x′}TiO₂, Li_{x′}NiₐCo_{b}Mn_{c}O₂, Li_{x′}FeₐMe_{b}PO₄ (Me=Mn, Co, Al, Ni, Nb, Mo, Ti, or their mixture, 0≤x′≤1, 0<a≤1, 0<b≤1, 0<c≤1).

The step 103 includes connecting the lithium adsorptive electrode to a negative port of a power supply and the lithium releasing electrode to a positive port of the power supply. The step 104 includes connecting the oxidative electrode and the reductive electrode through electrical wires. The reductive electrode comprises pure or partially reductive materials, including but not limited to, metallic elementary substances, reductive metal ions, anions, and reductive organic molecules. In some embodiments of the present disclosure, the reductive electrode may comprise Ag. The oxidative electrode comprises partially or fully oxidative materials, including but not limited to oxidated metal ions, oxidated acid groups, oxidated organic molecules. In some embodiments of the present disclosure the oxidative electrode may comprise AgCl. The electric wires connect the electric circuit.

The step 105 includes applying voltage to the lithium adsorptive electrode and the lithium releasing electrode sufficient for the lithium adsorptive electrode to adsorb lithium from the lithium containing fluid and the lithium releasing electrode to release lithium to the lithium collection fluid; wherein the lithium adsorptive electrode functions as a cathode and the lithium releasing electrode functions as an anode; and wherein the reductive electrode is reduced, and the oxidative electrode is oxidized. The voltage applied is 0-100V for each unit.

Embodiments of the present disclosure describe a method which further comprises cleaning the electrodes with fresh water and switching the positions of the two pairs of electrodes after a time period, wherein the time period comprises a cycle. In some embodiments the cycle is repeated every 0.1 to 1000 hours. The duration of the cycle depends on a number of factors, which include, but are not limited to: (i) temperature, (ii) concentration of the feed, (iii) voltage used, to carry out the electrochemical processes. In some embodiments of the present disclosure the cycle is repeated every 2 to 6 hours. In certain other embodiments of the present disclosure, the cycle is repeated every 2 hours. In some embodiments of the present disclosure the cycle is repeated every 0.1 to 10 hours. In some embodiments of the present disclosure the cycle is repeated every 5 to 20 hours. In some embodiments of the present disclosure the cycle is repeated every 20 to 100 hours. In some embodiments of the present disclosure the cycle is repeated every 80 to 200 hours. In some embodiments of the present disclosure the cycle is repeated every 150 to 500 hours. In some embodiments of the present disclosure the cycle is repeated every 300 to 750 hours. In some embodiments of the present disclosure the cycle is repeated every 250 to 1000 hours. The cycle includes steps 101 to 105. If the active materials in the electrodes run out, exchanging the electrodes will recover the electrochemical configuration. In some embodiments of the present disclosure, the lithium extraction electrode may comprise LiₓFePO₄ and the corresponding lithium releasing electrode comprises Li_{x′}FePO₄ where 0≤x≤x′≤1. After adsorption, the electrode (LiₓFePO₄) in the lithium extraction chamber is transformed to Li_{x′}FePO₄; and the electrode in the lithium collection chamber (Li_{x′}FePO₄) is transformed to LiₓFePO₄. By switching the position of electrodes, the electrochemical configuration is resumed.

Embodiments of the present disclosure describe a decoupled electrochemical lithium extraction process. The method comprises steps that include a lithium extraction chamber, a lithium collection chamber, a lithium adsorptive/releasing electrode pair, and a reductive/oxidative electrode pair. The two chambers are physically isolated from each other. Lithium brines are fed into the lithium extraction chamber. The lithium adsorptive and reductive electrodes are placed into the lithium extraction chamber. Under the electrochemical reaction conditions, the lithium adsorptive electrode selectively picks up lithium from the brines. At the same time, the lithium releasing electrode and the oxidative electrode are placed into the lithium collection chamber. The lithium releasing electrode releases lithium into the lithium collection fluid or solution. Next, the two pairs of electrodes switch their positions, and the electrochemical reactions continue. Furthermore, the built-up concentration differences between the lithium extraction fluid or solution and the lithium collection fluid or solution can facilitate the electrochemical reactions, which leads to a reduction in energy consumption. Some embodiments of the present disclosure showed that the process had achieved high selectivity and high efficiency in the extraction of lithium from various lithium brines, especially from brines containing low lithium concentration (<350 ppm) but high Mg/Li ratio (>20) and high salinity (>3.5%).

Some embodiments of the present disclosure describe a method wherein the lithium containing fluid or solution comprises, but is not limited to, one or more of lithium brine, Dead Sea water, salt-lake water, sea water, wastewater or solutions prepared by the dissolution of lithium ores.

Certain other embodiments of the present disclosure describe a method, wherein the lithium containing fluid comprises solutions produced in industries like electricity generation, salt manufacture, mining, oil extraction and gas extraction. Other embodiments of the present disclosure describe a method, wherein the brine comprises a Li concentration of 47.36 ppm, with Mg 64851.9 ppm, Ca 24482.7 ppm, Na 1714.3 ppm, K 1352.8 ppm.

Some embodiments of the present disclosure describe a method, wherein the reductive/oxidative electrode pair comprise Ag/AgCl mixed electrode. Certain other embodiments of the present disclosure describe a method, wherein the Ag/AgCl mixed electrode comprises Ag:AgCl in 50%: 50% molar ratio. Any ions that can generate sediment with the oxidative and reductive electrode can be used. Yet other embodiments of the present disclosure describe a method, wherein the reductive/oxidative electrode pairs comprise ions that include, but are not limited to, Cl⁻, Br⁻, SO4²⁻.

Embodiments of the present disclosure describe a method further comprising a membrane separating the lithium extraction electrode and the reductive electrode in the lithium extraction chamber, wherein the membrane separation creates a lithium extraction compartment and a reductive compartment in the lithium extraction chamber. The method further comprising a membrane separating the lithium releasing electrode and the oxidative electrode in the lithium collection chamber, wherein the membrane separation creates a lithium releasing compartment and an oxidative compartment in the lithium collection chamber. Some embodiments of the present disclosure describe the method, wherein the reductive compartment and the oxidative compartment accommodate the liquid or fluid reductive/oxidative electrode pairs. Certain other embodiments of the present disclosure describe wherein the liquid reductive/oxidative electrode pairs comprise, but is not limited to, Fe²⁺/Fe³⁺, [Fe(CN)₆]⁴⁻/[Fe(CN)₆]³⁻, X⁻/X₂, X/XO₃⁻, (X═Cl, Br, I), Hg/Hg₂Cl₂, hydroquinone/1,4-benzoquinone.

Some embodiments of the present disclosure describe a method wherein the membrane comprises ion exchange membranes. Yet other embodiments of the present disclosure describe a method, wherein the ion-exchange membrane comprises anion exchange membrane, cation exchange membrane, nanofiltration membrane or membranes that separate different ions from each other. Certain other embodiments of the present disclosure describe a method, wherein the membrane comprises, but is not limited to, Nafion®, DOWEX Marathon®, Aldex®, LEWATIT®, SACMP®, Tulsion®, Neosepta®, Sustainion®, Fumasep®, Tokuyama© A series, AEMION™, and Fujifilm® ion membranes.

Some embodiments of the present disclosure describe a method, wherein the reductive electrode and the oxidative electrode comprise electron conductive materials. Some embodiments of the present disclosure describe a method, wherein the electron conductive materials comprise, but are not limited to, one or more of carbon cloth, graphite, titanium, Pt, Ru, Ir, Ni. Certain other embodiments of the present disclosure describe a method, wherein membranes in the lithium extraction chamber and the membranes in the lithium collection chamber comprise same or different ion-exchange membranes.

System for Extraction of Lithium from Lithium Containing Fluids

Embodiments of the present disclosure describe a system for extraction of lithium from lithium containing fluids. The system comprises: a) a lithium extraction chamber including a lithium containing fluid; b) a lithium collection chamber including a lithium collection fluid; c) a lithium adsorptive/releasing electrode pair; wherein the lithium adsorptive electrode is in fluidic communication with the lithium extraction chamber; and wherein the lithium releasing electrode is in fluidic communication with the lithium collection chamber; d) a reductive/oxidative electrode pair; wherein the reductive electrode is in fluidic communication with the lithium extraction chamber and the oxidative electrode is in fluidic communication with the lithium collection chamber; e) a power supply; wherein the lithium adsorptive electrode is immersed in the lithium containing fluid and connected to a negative port of the power supply, and wherein the lithium releasing electrode is immersed in the lithium collection fluid and connected to the positive port of the power supply; and wherein the reductive electrode is immersed in the lithium containing fluid, and the oxidative electrode is immersed in the lithium collection fluid; and wherein the reductive electrode and the oxidative electrode are connected using an electrical wire; and wherein lithium is extracted without using membranes. The system, wherein the voltage is sufficient for the lithium releasing electrode to function as an anode and the lithium adsorptive electrode to function as a cathode. Embodiments of the present disclosure describe a system, wherein the voltage applied is 0-100V.

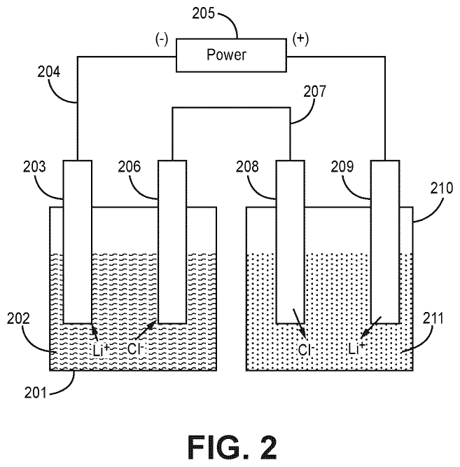

FIG. 2 is a schematic representation of the system, according to some embodiments of the present disclosure. FIG. 2 shows the decoupled electrochemical lithium extraction system or equipment using two pairs of solid electrodes. 201 is the lithium extraction chamber holding the lithium containing fluid, for example, seawater (202). 203 is the lithium adsorption electrode. FePO₄ is employed as an example to describe the process. However, FePO₄ can be replaced by any lithium selective materials including but not limited to MnO₂, TiₐO₂ₐ, Mn₂O₄, NiₐCo_{b}Mn_{c}O₂ wherein 0<a≤1, 0<b≤1, 0<c≤1. 206 is the reductive electrode. Silver (Ag) is employed as an example to describe the process. However, Ag can be replaced by any reductive materials, including but not limited to metallic elementary substances, reductive metal ions, anions, and reductive organic molecules. 210 is the lithium collection chamber holding the lithium collection fluid or solution (211). 209 is the corresponding lithium releasing electrode, i.e., Li_{x′}FePO₄ (0<x′≤1), when FePO₄ is employed. However, it can be replaced by the corresponding releasing materials when other lithium selective materials are used. The lithium releasing electrode is made of the corresponding lithium adsorbed form of the lithium adsorptive electrode, which includes, but is not limited to, Li_{x′}FePO₄, Li_{x′}MnO₂, Li_{x′}Mn₂O₄, Li_{x′}TiO₂, Li_{x′}NiₐCo_{b}Mn_{c}O₂, Li_{x′}FeₐMe_{b}PO₄ (Me=Mn, Co, Al, Ni, Nb, Mo, Ti, or their mixture, 0≤x′≤1, 0<a≤1, 0<b≤1, 0<c<1). 208 is the oxidative electrode. Silver chloride (AgCl) is employed as an example to describe the process. However, silver chloride can be replaced by other oxidative materials, including but not limited to oxidated metal ions, oxidated acid groups, oxidated organic molecules, etc. The electric wires (204, 207) connect the electric circuit, and 205 is the power supply.

When voltage applied, the following reactions will occur:

### Lithium Extraction Chamber:

$$- ) {Li}_{x} {FePO}_{4} ( in electrode ) + z {e}^{-} + z Li ( in seawater ) = {Li}_{{x}^{′}} {FePO}_{4} ( in electrode ) \qquad R1$$

$$+ ) {AgCl}_{y} ( in electrode ) - z e - + z {Cl}^{-} ( in seawater ) = {AgCl}_{{y}^{′}} ( in electrode ) \qquad R2$$

### Lithium Collection Chamber:

$$- ) {AgCl}_{{y}^{′}} ( in electrode ) + z {e}^{-} = {AgCl}_{y} ( in electrode ) + z {Cl}^{-} ( in collection solution ) \qquad R3$$

$$+ ) {Li}_{x} {FePO}_{4} ( in electrode ) = {Li}_{x} {FePO}_{4} ( in electrode ) + z {e}^{-} + z {Li}^{+} ( in collection solution ) \qquad R4$$

### Overall Reaction:

$${Li}^{+} + {Cl}^{-} ( in seawater ) = {Li}^{+} + {Cl}^{-} ( in collection solution )$$

If the active materials in the electrodes run out, exchanging the electrodes will recover the electrode configuration. After adsorption, the electrode (LiₓFePO₄) in the lithium extraction chamber is transformed to Li_{x′}FePO₄; and the electrode in the lithium collection chamber (Li_{x′}FePO₄) is transformed to LiₓFePO₄. By switching the position of electrodes, the electrochemical configuration is resumed.

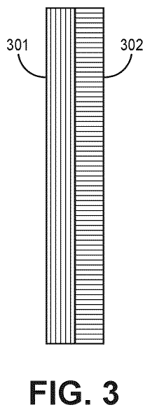

The structure of the lithium adsorptive electrode (203) is shown in FIG. 3. As shown in FIG. 3, the lithium selective adsorptive materials (302), employed as active materials, are coated on the current collector (301), which is made from the electron conductive materials, including but not limited to, carbon cloth, graphite, titanium, metal (Pt, Ru, Ir, Ni) etc., using either polymers as binders or advanced deposit technologies like atomic layer deposition, chemical vapor deposition, vapor deposition, and plasma-enhanced vapor deposition. Electron conductors, including, but not limited to, carbon powder, platinum power, gold power can be added optionally into 302 for better performance. The structures of the reductive electrode, the oxidative electrode, and the lithium releasing electrode are similar to that of the lithium adsorptive electrode (203).

Some embodiments of the present disclosure describe a system wherein the two pairs of electrodes switch their positions after a time period, wherein the time period comprises a cycle. In some embodiments, the cycle is repeated every 0.1 to 1000 hours. The duration of the cycle depends on a number of factors, which include, but are not limited to: (i) temperature, (ii) concentration of the feed, (iii) voltage used to carry out the electrochemical processes. In some embodiments of the present disclosure the cycle is repeated every 2 to 6 hours. In certain other embodiments of the present disclosure, the cycle is repeated every 2 hours. In some embodiments of the present disclosure the cycle is repeated every 0.1 to 10 hours. In some embodiments of the present disclosure the cycle is repeated every 5 to 20 hours. In some embodiments of the present disclosure the cycle is repeated every 20 to 100 hours. In some embodiments of the present disclosure the cycle is repeated every 80 to 200 hours. In some embodiments of the present disclosure the cycle is repeated every 150 to 500 hours. In some embodiments of the present disclosure the cycle is repeated every 300 to 750 hours. In some embodiments of the present disclosure the cycle is repeated every 250 to 1000 hours.

If the active materials in the electrodes run out, exchanging the electrodes will recover the electrochemical configuration. In some embodiments of the system of the present disclosure, the lithium extraction electrode may comprise LiₓFePO₄ and the corresponding lithium releasing electrode comprises LiₓFePO₄ where 0≤x≤x′≤1. After adsorption, the electrode (LiₓFePO₄) in the lithium extraction chamber is transformed to Li_{x′}FePO₄; and the electrode in the lithium collection chamber (Li_{x′}FePO₄) is transformed to LiₓFePO₄. By switching the position of electrodes, the electrochemical configuration is resumed.

Embodiments of the present disclosure describe a system wherein the lithium adsorptive electrode is made from materials that can selectively adsorb lithium from other interference cations, which include, but is not limited to, LiₓFePO₄, LiₓMnO₂, LiₓMn₂O₄, LiₓTiO₂, LiₓNiₐCo_{b}Mn_{c}O₂, LiₓFeₐMe_{b}PO₄ (Me=Mn, Co, Al, Ni, Nb, Mo, Ti, or their mixture, 0≤x<1, 0<a≤1, 0<b≤1, 0<c<1) and wherein the lithium releasing electrode is made of the corresponding lithium adsorbed form of the lithium adsorptive electrode, which includes, but is not limited to, Li_{x′}FePO₄, Li_{x′}MnO₂, Li_{x′}Mn₂O₄, Li_{x′}TiO₂, Li_{x′}NiₐCo_{b}Mn_{c}O₂, Li_{x′}FeₐMe_{b}PO₄ (Me=Mn, Co, Al, Ni, Nb, Mo, Ti, or their mixture, 0<x′≤1, 0<a≤1, 0<b≤1, 0<c≤1).

Some embodiments of the present disclosure describe a system, wherein the reductive/oxidative electrode pair comprise Ag/AgCl mixed electrode. Certain other embodiments of the present disclosure describe a system, wherein the Ag/AgCl mixed electrode comprises Ag:AgCl in 50%: 50% molar ratio. Any ions that can generate sediment with the oxidative and reductive electrode can be used. Yet other embodiments of the present disclosure describe a method, wherein the reductive/oxidative electrode pairs comprise ions that include, but are not limited to, Cl⁻, Br⁻, SO4²⁻.

Some embodiments of the present disclosure describe a system wherein the lithium containing fluid or solution comprises, but is not limited to, one or more of lithium brine, dead sea water, salt-lake water, sea water, wastewater or solutions prepared by the dissolution of lithium ores.

Certain other embodiments of the present disclosure describe a system, wherein the lithium containing fluid comprises solutions produced in industries like electricity generation, salt manufacture, mining, oil extraction and gas extraction.

System for Extraction of Lithium from Lithium Containing Fluids Using Fluid Electrodes

Embodiments of the present disclosure describe a system for extraction of lithium from lithium containing fluids or solutions, which comprises: a) a lithium extraction chamber including a lithium containing fluid; b) a lithium collection chamber including a lithium collection fluid; c) a lithium adsorptive/releasing electrode pair; wherein the lithium adsorptive electrode is in fluidic communication with the lithium extraction chamber; and wherein the lithium releasing electrode is in fluidic communication with the lithium collection chamber; d) a fluid reductive/oxidative electrode pair; wherein the reductive electrode is in fluidic communication with the lithium extraction chamber and the oxidative electrode is in fluidic communication with the lithium collection chamber; e) a first membrane separating the lithium adsorptive electrode and the reductive electrode in the lithium extraction chamber sufficient to form a lithium extraction compartment and a reductive compartment; and f) a second membrane separating the lithium releasing electrode and the oxidative electrode in the lithium collection chamber sufficient to form a lithium collection compartment and an oxidative compartment; g) a power supply; wherein the lithium adsorptive electrode is immersed in the lithium containing fluid and connected to a negative port of the power supply, and wherein the lithium releasing electrode is immersed in the lithium collection fluid and connected to the positive port of the power supply; and wherein the reductive electrode is immersed in the lithium containing fluid, and the oxidative electrode is immersed in the lithium collection fluid; and wherein the reductive electrode and the oxidative electrode are connected using an electrical wire.

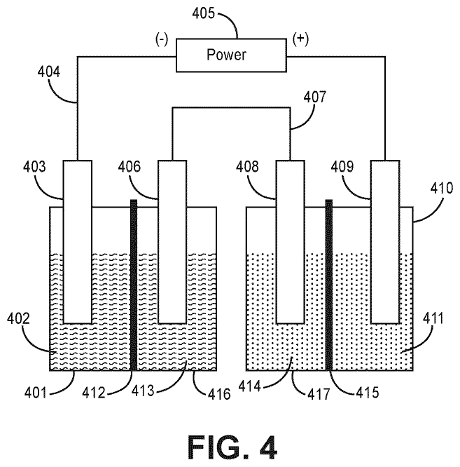

FIG. 4 shows the schematic representation of a system for extraction of lithium from lithium containing fluids or solutions using fluid electrodes, wherein the system a third compartment (Reductive compartment, 416) and a fourth compartment (Oxidative compartment, 417) are created to accommodate the fluid reductive/oxidative electrode pairs (413/414, respectively), which include but is not limited to, Fe²⁺/Fe³⁺, [Fe(CN)₆]⁴⁻/[Fe(CN)₆]³⁻, X⁻/X₂, X/XO₃⁻, (X═Cl, Br, I), Hg/Hg₂Cl₂, hydroquinone/1,4-benzoquinone. The reductive compartment (416) is divided from the lithium extraction compartment by an ion-exchange membrane (IEM, 412), and the oxidative compartment (417) is separated from the lithium collection compartment by an ion-exchange membrane (415). Electron conductive materials (carbon cloth, graphite, titanium, Pt, Ru, Ir, Ni, etc.) are immersed in the reductive and oxidative compartment to serve as the electroconductive electrodes (406 and 408), respectively. IEM 412 and 415 can be either the same or different ion-exchange membranes.

Embodiments of the present disclosure describe a system wherein the lithium adsorptive electrode is made from materials that can selectively adsorb lithium from other interference cations, which include, but is not limited to, LiₓFePO₄, LiₓMnO₂, LiₓMn₂O₄, LiₓTiO₂, LiₓNiₐCo_{b}Mn_{c}O₂, LiₓFeₐMe_{b}PO₄ (Me=Mn, Co, Al, Ni, Nb, Mo, Ti, or their mixture, 0≤x<1, 0<a≤1, 0<b≤1, 0<c≤1) and wherein the lithium releasing electrode is made of the corresponding lithium adsorbed form of the lithium adsorptive electrode, which includes, but is not limited to, Li_{x′}FePO₄, Li_{x′}MnO₂, Li_{x′}Mn₂O₄, Li_{x′}TiO₂, Li_{x′}NiₐCo_{b}Mn_{c}O₂, Li_{x′}FeₐMe_{b}PO₄ (Me=Mn, Co, Al, Ni, Nb, Mo, Ti, or their mixture, 0<x′≤1, 0<a≤1, 0<b≤1, 0<c≤1).

Taking [Fe(CN)₆]⁴⁻/[Fe(CN)₆]³⁻ as an example of the fluid reductive/oxidative electrode pair, the involved electrochemical reactions in the process are the following:

### Lithium Extraction Compartment

$$- ) {Li}_{x} {FePO}_{4} ( in electrode ) + z {e}^{-} + z {Li}^{+} ( in seawater ) = {Li}_{{x}^{′}} {FePO}_{4} ( in electrode ) \qquad R5$$

### Reductive Compartment

$$+ ) {z [ Fe {( CN )}_{6} ]}^{4 -} ( reductive compartment ) - z {e}^{-} = {z [ {Fe ( CN )}_{6} ]}^{3 -} ( reductive compartment ) \qquad R6$$

### Oxidative Compartment

$$- ) {z [ {Fe ( CN )}_{6} ]}^{3 -} ( oxidated compartment ) + z {e}^{-} = {z [ {Fe ( CN )}_{6} ]}^{4 -} ( oxidated compartment ) \qquad R7$$

### Lithium Collection Compartment

$$+ ) {Li}_{x} {FePO}_{4} ( in electrode ) - z {e}^{-} = {Li}_{x} {FePO}_{4} ( in electrode ) + z {Li}^{+} ( in collection solution ) \qquad R8$$

### Total Reaction:

$${Li}^{+} ( in seawater ) = {Li}^{+} ( in collection solution )$$

If the active materials of the electrodes run out, the electrode configuration can be recovered by exchanging the adsorptive/releasing electrodes' positions in the lithium extraction and collection chambers, and the reductive and oxidative electrodes' positions in reductive and oxidative compartments, respectively.

Embodiments of the present disclosure describe a system, wherein the ion exchange membrane can be an anion exchange membrane, cation exchange membrane, or nanofiltration membrane, which can separate different ions from each other. Some embodiments of the present disclosure describe a system, wherein the IEM includes but is not limited to Nafion®, DOWEX Marathon®, Aldex®, LEWATIT®, SACMP®, Tulsion®, Neosepta®, Sustainion®, Fumasep®, Tokuyama© A series, AEMION™, and Fujifilm® ion membranes.

Embodiments of the present disclosure describe a system, wherein the two pairs of electrodes undergo electrochemical reaction sufficient for the lithium adsorptive electrode to adsorb lithium from the lithium containing fluid and the lithium releasing electrode to release lithium to the lithium collection fluid; and wherein the electrochemical reaction is sufficient for the reductive electrode to be reduced and the oxidative electrode to be oxidized. Some embodiments of the present disclosure describe a system wherein the two pairs of electrodes switch their positions after a time period, wherein the time period comprises a cycle In some embodiments of the present disclosure, the aforementioned reactions comprise 0.1 to 1000 hours (defined as one cycle), wherein lithium is transferred from the lithium containing solution to the lithium collection solution. Some embodiments of the present disclosure describe a system, wherein the two pairs of electrodes switch their positions after every cycle of the electrochemical reaction. Because the lithium containing fluid and lithium collection fluid are loaded in two isolated chambers; the other ions, which are not adsorbed by lithium adsorptive electrode are fully blocked and cannot transport from lithium containing fluid to lithium collection fluid. In the same way, the lithium ion cannot travel back from lithium collection fluid to lithium containing fluid due to the feature of lithium adsorptive/releasing electrodes.

In some embodiments, the cycle is repeated every 0.1 to 1000 hours. The duration of the cycle depends on a number of factors, which include, but are not limited to: (i) temperature, (ii) concentration of the feed, (iii) voltage used, to carry out the electrochemical processes. In some embodiments of the present disclosure the cycle is repeated every 2 to 6 hours. In certain other embodiments of the present disclosure, the cycle is repeated every 2 hours. In some embodiments of the present disclosure the cycle is repeated every 0.1 to 10 hours. In some embodiments of the present disclosure the cycle is repeated every 5 to 20 hours. In some embodiments of the present disclosure the cycle is repeated every 20 to 100 hours. In some embodiments of the present disclosure the cycle is repeated every 80 to 200 hours. In some embodiments of the present disclosure the cycle is repeated every 150 to 500 hours. In some embodiments of the present disclosure the cycle is repeated every 300 to 750 hours. In some embodiments of the present disclosure the cycle is repeated every 250 to 1000 hours.

Embodiments of the present disclosure describe a system, wherein the voltage is applied to the lithium adsorptive electrode and the lithium releasing electrode and wherein the voltage is sufficient for the lithium releasing electrode to function as an anode and the lithium adsorptive electrode to function as a cathode. Embodiments of the present disclosure describe a system, wherein the voltage applied is in the range of 0-100V.

Some embodiments of the present disclosure a system for the extraction of lithium from various lithium brines, especially from brines containing low lithium concentration (<350 ppm) but high Mg/Li ratio (>20) and high salinity (>3.5%).

Some embodiments of the present disclosure describe a system wherein the lithium containing fluid or solution comprises, but is not limited to, one or more of lithium brine, dead sea water, salt-lake water, sea water, wastewater or solutions prepared by the dissolution of lithium ores.

Certain other embodiments of the present disclosure describe a system, wherein the lithium containing fluid comprise solutions produced in industries like electricity generation, salt manufacture, mining, oil extraction and gas extraction. Other embodiments of the present disclosure describe a method, wherein the brine comprises a Li concentration of 47.36 ppm, with Mg 64851.9 ppm, Ca 24482.7 ppm, Na 1714.3 ppm, K 1352.8 ppm.

### EXAMPLES

### Example 1: Extraction of Lithium Using Two Pairs of Solid Electrodes

Preparation of lithium releasing electrode: 1.0 g polyvinylidene fluoride (PVDF, polymer binder) was dissolved in 1-Methyl-2-Pyrrolidone (NMP) to form a 2.5 wt. % solution. Then, 8.0 g LiFePO₄ and 1.0 g carbon black were dispersed into it, which was stirred for 12 h to form a homogeneous paste. The paste was coated on a carbon cloth using a coating machine, dried at 120° C. for 4 h, and pressed at 155° C. and 4000 psi for 5 min to obtain the lithium releasing electrode.

Preparation of the lithium adsorptive electrode: the aforementioned lithium releasing electrode was immersed into a beaker filled with 0.5 M aqueous KCl and then connected to the positive port of a power supply. A blank carbon cloth was employed as the counter electrode, which was connected to the negative port of the power supply and then placed into the same beaker. A voltage of 1.05 V was applied for 24 h to fully discharge lithium from the lithium releasing electrode and convert it to the lithium adsorptive electrode.

Typically, Ag and AgCl are used separately as the corresponding reductive and oxidative electrodes. However, two identical Ag/AgCl mixed electrodes (Ag:AgCl=50%:50% in mole) were used as the reductive electrode (206 in FIG. 2) and the oxidative electrode (208 in FIG. 2), respectively. The advantage of a mixed electrode is that it can stabilize the potential difference between the reductive electrode (206) and the oxidative electrode (208). The Ag, AgCl, and Ag/AgCl mixed electrodes were prepared as follows: 8.0 g Ag nanopowder (diameter=500-1000 nm) and 1.0 g carbon black were dispersed into 20.0 mL Sustainion® XA-9 Alkaline Ionomer (5 wt. %) solution, and the mixture was stirred for 4 to obtain a homogeneous paste. The paste was coated on a carbon cloth using a coating machine, dried at 120° C. under vacuum for 4 h, and pressed at 155° C. and 4000 psi for 5 min to obtain the Ag electrode. The Ag electrode was divided into two equal parts (Part A and Part B). Part A was connected to the positive port of a power supply and immersed in a beaker filled with 0.5 M aqueous HCl. A blank carbon cloth was employed as the counter electrode, which is connected to the negative port of the power supply and placed into the same beaker. A voltage of 1.05 V was applied for 4 h to convert the Part A electrode to the AgCl electrode. The Ag/AgCl mixed electrode was prepared by attaching the Part A electrode with the Part B electrode by pressing them at 155° C. and 4000 psi for 5 min.

A brine (Dead Sea water) having a Li concentration of 47.36 ppm, with Mg 64851.9 ppm, Ca 24482.7 ppm, Na 1714.3 ppm, K 1352.8 ppm, was used. The equipment shown in FIG. 2 was used. The lithium extraction chamber (201) was filled with 2.5 L Dead Sea water, and the lithium collection chamber (210) was filled with 65 mL Cs₂SO₄ aqueous solution (0.1 M). All the electrodes had the size of 4.5×1.5 cm². The distance between the lithium adsorptive electrode 203 and the reductive electrode 206 is 1.0 cm. The same distance was applied to the lithium releasing electrode 208 and the oxidative electrode 209). A voltage of 0.6 V was applied using a DC power supply. Every 2 h (defined as the duration of one cycle), the electrodes were taken out, washed with warm DI water (50° C.), and then switched their positions according to their pairs. At the same time, the ionic concentrations in the lithium collection chamber were measured by the inductively coupled plasma (ICP) technique, and the results are listed in Table 1 and Table 2. In Table 1 and Table 2, the serial numbers refer to the number of cycles and electrode positions exchange. For example, 1st refers to the ion concentrations in lithium collection fluid after 1 cycle of electrochemical reactions and 1 times of electrode positions exchange, and 5th refers to the ion concentrations in lithium collection fluid after 5 cycles of electrochemical reactions and 5 times of electrode position switches.

TABLE 1
The concentration of ions in the lithium collection compartment
and the original solution in the lithium extraction compartment

| | Li/ppm | Na/ppm | K/ppm | Mg/ppm | Ca/ppm |
|---|---|---|---|---|---|
| Original | 47.4 | 1714.3 | 1352.8 | 64851.9 | 24482.7 |
| 1^{st} | 19.04 | 9.545 | 7.76 | 4.8 | 1.96 |
| 2^{nd} | 28.14 | 12.22 | 7.08 | 6.77 | 2.43 |
| 3^{rd} | 50.18 | 23.77 | 8.67 | 11.605 | 4.665 |
| 4^{th} | 57.89 | 29.945 | 8.32 | 16.285 | 6.27 |
| 5^{th} | 65.61 | 33.28 | 8.67 | 20.07 | 8.14 |
| 6^{th} | 71.11 | 37.305 | 7.82 | 18.885 | 9.2 |
| 7^{th} | 82.69 | 41.545 | 8.62 | 22.905 | 10.79 |

TABLE 2
The selectivity of ions based on mole

| | Li/Na | Li/K | Li/Mg | Li/Ca |
|---|---|---|---|---|
| 1^{st} | 236.78 | 232.27 | 18665.73 | 28780.10 |
| 2^{nd} | 403.81 | — | 21736.74 | 57362.09 |
| 3^{rd} | 226.51 | 1312.23 | 21450.35 | 29215.65 |
| 4^{th} | 148.21 | — | 7752.25 | 14231.83 |
| 5^{th} | 274.78 | 2088.07 | 9597.77 | 12230.86 |
| 6^{th} | 162.20 | — | — | 15372.28 |
| 7^{th} | 324.19 | 1370.29 | 13555.07 | 21577.09 |

### Example 2: Extraction of Lithium Using One Pair of Solid Electrodes and One Pair of Fluid Electrodes

The preparation of the lithium releasing electrode and lithium adsorptive electrode was the same as those of Example 1. As shown in FIG. 4, an anion exchange membrane (412 as shown in FIG. 4) was used to create a reductive compartment (416) from lithium extraction compartment (401), and an anion exchange membrane (415) was used to create an oxidative compartment (417) from lithium collection compartment. The reductive compartment and oxidative compartment were filled with K₄[Fe(CN)₆]/K₃[Fe(CN)₆] solution (0.1 M/0.1 M). Two carbon electrodes (406 and 408) were inserted and connected with each other by an electric wire.

A brine (Dead Sea water) having a Li concentration of 47.36 ppm, with Mg 64851.9 ppm, Ca 24482.7 ppm, Na 1714.3 ppm, K 1352.8 ppm, was used. The equipment shown in FIG. 4 was used. The lithium extraction compartment (401) was filled with 2.5 L Dead Sea water, and the lithium collection compartment (410) was filled with 65 mL Cs₂SO₄ aqueous solution (0.1 M). All the electrodes had the size of 4.5×1.5 cm². A voltage of 0.6 V was applied using a DC power supply. Every 2 h (defined as the duration of one cycle), the electrodes were taken out, washed with warm DI water (50° C.), and then switched their positions according to their pairs. At the same time, the ionic concentrations in the lithium collection chamber were measured by the inductively coupled plasma (ICP) technique, and the results are listed in Table 3 and Table 4. In Table 3 and Table 4, the serial numbers refer to the number of cycles and electrode positions exchange. For example, 1^{st} refers to the ion concentrations in lithium collection fluid after 1 cycle of electrochemical reactions and 1 times of electrode positions exchange, and 5^{th} refers to the ion concentrations in lithium collection fluid after 5 cycles of electrochemical reactions and 5 times of electrode position switches.

TABLE 3
The concentration of ions in the lithium collection compartment
and the original solution in the lithium extraction compartment

| | Li/ppm | Na/ppm | K/ppm | Mg/ppm | Ca/ppm |
|---|---|---|---|---|---|
| Original | 47.4 | 1714.3 | 1352.8 | 64851.9 | 24482.7 |
| 1^{st} | 0.15 | 9.68 | 18.02 | 7.87 | 1.41 |
| 2^{nd} | 8.74 | 12.21 | 19.11 | 9.39 | 2.15 |
| 3^{rd} | 19.61 | 13.92 | 18.75 | 10.23 | 2.6 |
| 4^{th} | 29.11 | 19.01 | 20.49 | 11.8 | 3.6 |
| 5^{th} | 33.17 | 20.79 | 20.6 | 12.42 | 4.12 |
| 6^{th} | 34.63 | 24.2 | 19.63 | 12.96 | 4.45 |
| 7^{th} | 38.13 | 26.65 | 19.72 | 13.46 | 4.98 |
| 8^{th} | 40.96 | 29.66 | 20.28 | 13.86 | 5.42 |
| 9^{th} | 45.36 | 33.46 | 20.46 | 14.79 | 6.79 |
| 10^{th} | 49.70 | 35.2 | 20.28 | 14.73 | 7.28 |

TABLE 4
The selectivity of ions based on mole

| | Li/Na | Li/K | Li/Mg | Li/Ca |
|---|---|---|---|---|
| 1^{st} | 0.56 | 0.24 | 26.08 | 54.95 |
| 2^{nd} | 122.80 | 224.92 | 7732.04 | 5995.73 |
| 3^{rd} | 229.90 | — | 17704.95 | 12476.65 |
| 4^{th} | 67.50 | 155.82 | 8278.82 | 4906.87 |
| 5^{th} | 82.49 | 1053.39 | 8959.40 | 4032.77 |
| 6^{th} | 15.48 | — | 3699.16 | 2285.18 |
| 7^{th} | 51.67 | 1109.89 | 9577.28 | 3410.93 |
| 8^{th} | 34.00 | 144.23 | 9679.90 | 3322.12 |
| 9^{th} | 41.88 | 697.65 | 6473.13 | 1658.87 |
| 10^{th} | 90.21 | — | — | 4574.83 |

The demonstrated examples showed that the process had achieved high selectivity and high efficiency in the extraction of lithium from various lithium brines, especially from brines containing low lithium concentration (<350 ppm) but high Mg/Li ratio (>20) and high salinity (>3.5%).

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims. Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus, the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for the purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A method for extraction of lithium from lithium containing fluids comprising:
(a) immersing a lithium adsorptive electrode and a reductive electrode in a lithium extraction chamber including a lithium containing fluid;
(b) immersing a lithium releasing electrode and an oxidative electrode in a lithium collection chamber including a lithium collection fluid;
(c) connecting the lithium adsorptive electrode to a negative port of a power supply and the lithium releasing electrode to a positive port of the power supply;
(d) connecting the oxidative electrode and the reductive electrode through electrical wires; and
(e) applying voltage to the lithium adsorptive electrode and the lithium releasing electrode sufficient for the lithium adsorptive electrode to adsorb lithium from the lithium containing fluid and the lithium releasing electrode to release lithium to the lithium collection fluid, wherein the lithium adsorptive electrode functions as a cathode and the lithium releasing electrode functions as an anode; and wherein the reductive electrode is reduced, and the oxidative electrode is oxidized.

2. (canceled)

3. The method of claim 1, further comprising switching the positions of the two pairs of electrodes after a time period.

4-9. (canceled)

10. The method of claim 1, wherein the lithium adsorptive electrode includes at least one of LixFePO4, LixMnO2, LixMn2O4, LixTiO2, LixNiaCobMncO2, and LixFeaMebPO4 (Me=Mn, Co, Al, Ni, Nb, Mo, Ti, or a mixture thereof, 0≤x<1, 0<a≤1, 0<b≤1, 0<c≤1).

11. (canceled)

12. The method of claim 1, wherein the lithium releasing electrode includes at least one of Lix′FePO4, Lix′MnO2, Lix′Mn2O4, Lix′TiaO2a, Lix′NiaCobMncO2, and Lix′FeaMebPO4 (Me=Mn, Co, Al, Ni, Nb, Mo, Ti, or a mixture thereof, 0<x′≤1, 0<a≤1, 0<b≤1, 0<c≤1).

13-14. (canceled)

15. The method of claim 1, wherein the reductive electrode and the oxidative electrode include an Ag/AgCl mixed electrode.

16. (canceled)

17. The method of claim 1, further comprising a membrane separating the lithium adsorptive electrode and the reductive electrode in the lithium extraction chamber.

18. (canceled)

19. The method of claim 1, further comprising a membrane separating the lithium releasing electrode and the oxidative electrode in the lithium collection chamber.

20-21. (canceled)

22. The method of claim 19, wherein the reductive electrode and the oxidative electrode include at least one of Fe2+/Fe3+, [Fe(CN)6]4−/[Fe(CN)6]3−, X−/X2, X/XO3−, (X═Cl, Br, I), Hg/Hg2Cl2, and hydroquinone/1,4-benzoquinone.

23. The method of claim 19, wherein the membrane comprises ion exchange membranes.

24-30. (canceled)

31. A system for extraction of lithium from lithium containing fluid comprising,
a lithium extraction chamber including a lithium containing fluid;
a lithium collection chamber including a lithium collection fluid;
a lithium adsorptive/releasing electrode pair including a lithium adsorptive electrode and a lithium releasing electrode; wherein the lithium adsorptive electrode is in fluidic communication with the lithium extraction chamber; and wherein the lithium releasing electrode is in fluidic communication with the lithium collection chamber;
a reductive/oxidative electrode pair including a reductive electrode and an oxidative electrode; wherein the reductive electrode is in fluidic communication with the lithium extraction chamber and the oxidative electrode is in fluidic communication with the lithium collection chamber;
a power supply; wherein the lithium adsorptive electrode is immersed in the lithium containing fluid and connected to a negative port of the power supply, and wherein the lithium releasing electrode is immersed in the lithium collection fluid and connected to a positive port of the power supply;
wherein the reductive electrode is immersed in the lithium containing fluid, and the oxidative electrode is immersed in the lithium collection fluid; and wherein the reductive electrode and the oxidative electrode are connected using an electrical wire;
and wherein lithium is extracted without using membranes.

32-34. (canceled)

35. The system of claim 31, wherein the two pairs of electrodes undergo electrochemical reaction sufficient for the lithium adsorptive electrode to adsorb lithium from the lithium containing fluid and the lithium releasing electrode to release lithium to the lithium collection fluid.

36. The system of claim 35, wherein the electrochemical reaction is sufficient for the reductive electrode to be reduced and the oxidative electrode to be oxidized.

37. The system of claim 31, wherein the two pairs of electrodes switch their positions after a time period, wherein a time period comprises a cycle.

38-43. (canceled)

44. The system of claim 31, wherein the lithium adsorptive electrode includes at least one of LixFePO4, LixMnO2, LixMn2O4, LixTiO2, LixNiaCobMncO2, and LixFeaMebPO4 (Me=Mn, Co, Al, Ni, Nb, Mo, Ti, or a mixture thereof, 0≤x<1, 0<a≤1, 0<b≤1, 0<c≤1).

45. The system of claim 31, wherein the lithium releasing electrode comprises a corresponding lithium adsorbed form of the lithium adsorptive electrode.

46. The system of claim 31, wherein the lithium releasing electrode includes at least one of Lix′FePO4, Lix′MnO2, Lix′Mn2O4, Lix′TiaO2a, Lix′NiaCobMncO2, and Lix′FeaMebPO4 (Me=Mn, Co, Al, Ni, Nb, Mo, Ti, or a mixture thereof, 0<x′≤1, 0<a≤1, 0<b≤1, 0<c≤1).

47. The system of claim 31, wherein the reductive electrode of the reductive/oxidative electrode pair comprises one or more of silver, metallic elementary substances, reductive metal ions, anions, reductive organic molecules.

48. The system of claim 47, wherein the oxidative electrode of the reductive/oxidative electrode pair comprises one or more of silver chloride, oxidated metal ions, oxidated acid groups, oxidated organic molecules.

49. The system of claim 47, wherein the reductive/oxidative electrode pair comprise Ag/AgCl mixed electrode.

50-52. (canceled)

53. A system for extraction of lithium from a lithium containing fluid using fluid electrodes comprising,
a lithium extraction chamber including a lithium containing fluid;
a lithium collection chamber including a lithium collection fluid;
a lithium adsorptive/releasing electrode pair including a lithium adsorptive electrode and a lithium releasing electrode; wherein the lithium adsorptive electrode is in fluidic communication with the lithium extraction chamber; and wherein the lithium releasing electrode is in fluidic communication with the lithium collection chamber;
a fluid reductive/oxidative electrode pair including a reductive electrode and an oxidative electrode; wherein the reductive electrode is in fluidic communication with the lithium extraction chamber and the oxidative electrode is in fluidic communication with the lithium collection chamber;
a first membrane separating the lithium extraction electrode and the reductive electrode in the lithium extraction chamber sufficient to form a lithium extraction compartment and a reductive compartment; and
a second membrane separating the lithium releasing electrode and the oxidative electrode in the lithium collection chamber sufficient to form a lithium collection compartment and an oxidative compartment; and
a power supply; wherein the lithium adsorptive electrode is immersed in the lithium containing fluid and connected to a negative port of the power supply, and wherein the lithium releasing electrode is immersed in the lithium collection fluid and connected to a positive port of the power supply;
wherein the reductive electrode is immersed in the lithium containing fluid, and the oxidative electrode is immersed in the lithium collection fluid; and wherein the reductive electrode and the oxidative electrode are connected using an electrical wire.

54-77. (canceled)
